(19) United States
(12) Patent Application Publication
(10) Pub. No.: US 2017/0294848 A1
(43) Pub. Date: Oct. 12, 2017

(54) METHOD AND DEVICE FOR AC FED SWITCH MODE POWER SUPPLY BASED ON NORMALLY ON TRANSISTORS

(71) Applicant: VISIC TECHNOLOGIES LTD., Nes Ziona (IL)

(72) Inventors: Giora LEVIN, Tel Aviv (IL); Gregory BUNIN, Tel-Aviv (IL)

(21) Appl. No.: 15/481,747

(22) Filed: Apr. 7, 2017

Related U.S. Application Data
(60) Provisional application No. 62/319,296, filed on Apr. 7, 2016.

(51) Int. Cl. H02M 5/453; H02M 7/5387; H02M 1/092; H02M 7/21; H02M 1/44

(52) U.S. Cl. CPC H02M 5/453; H02M 7/21; H02M 1/44; H02M 1/092; H02M 7/53873

(57) ABSTRACT

A device for providing high DC voltage using a solid state normally open switch. The solid state switch is controlled to gradually rise the voltage of the DC output by applying ON/OFF modulation scheme. The modulation scheme opens the switch initially for a very short time duration around the zero crossing of the input AC voltage and gradually the duration of the ON state extends until the switch remains constantly open.

### CROSS REFERENCE TO RELATED APPLICATIONS

This application claims the benefit of U.S. Provisional Patent Application No. 62/319,296, filed on Apr. 7, 2016 and entitled THE METHOD AND THE DEVICE FOR AC FED SWITCH MODE POWER SUPPLY BASED ON NORMALLY ON TRANSISTORS, which is incorporated in their entirety herein by reference.

### BACKGROUND OF THE INVENTION

Wide band gap semiconductor (WBG) based devices like GaN High Electron Mobility Transistors (HEMT) of SiC JFETs (Junction Field Effect Transistor) show tremendous improvement for power electronic applications, such as operating at very high frequency due to lower capacitance and having higher gate threshold voltage, versus more common Si MOSFETS or Insulated Gate Bipolar (IGBT) transistors. “Normally on” WBG transistors typically have better figure of merits (FOM) like Rdson *Coss (transistor output capacitance at ON state), Rdson*Qg (transistor gate charge at ON state) and Rdson temperature (transistor junction temperature at ON state) dependence versus their counterpart “normally-off” transistors due to physical principle of its design and manufacturing. In addition, “normally on” GaN HEMT have a proven record of reliable operation in the field of RF application.

Commonly used Si MOSFET and IGBT in power functional circuitries are used as “normally off” in order to comply with safety regulations, such as addressing the risk of unintentional and undesired short circuit on the power input bus.

There is a need to provide power functional circuitries using “normally on” operating design in order to enjoy the improved FOM of WBG of the “normally on” transistors and solve the risks associated with such circuitry in order to comply with the safety regulations for AC fed switch mode power supplies.

### SUMMARY OF THE INVENTION

A device for controlling an AC fed normally on switch for high voltage DC is disclosed comprising a high DC voltage switch adapted to operate in a normally on mode, the switch to provide high DC voltage to a HV bus when in ON state, a discharge switch adapted to provide controlled discharge path of the HV bus to a ground line, a set of high side switch and low side switch connected in a totem pole arrangement between terminal connectable to the HV bus and the ground line, a midpoint output terminal connected between the high side switch and low side switch, a first control terminal to provide control signal to change the mode of the high DC voltage switch between ON state and OFF state, a second control terminal to provide control signal to change the mode of the discharge switch between ON state an OFF state and a third and a fourth control terminals to provide control signals to change the mode of the high side switch and of the low side switch, respectively, between ON state and OFF state.

In some embodiments, the device further comprises at least one signal driver to match the signal of at least the first, the second, the third and the fourth control terminals to the input control terminal of the respective high DC voltage switch, the discharge switch, the high side switch and the low side switch, respectively.

In some embodiments, all the elements of the device are performed as an integrated circuit (IC) on a single chip.

In some embodiments, in at least one of the high DC voltage switch, the discharge switch, the high side switch and the low side switch a resistor in the range of at least several mega ohms may be connected between its source and its die backside.

In some embodiments, each of the high DC voltage switch, the discharge switch, the high side switch and the low side switch are transistors of one of GaN HEMT transistor or SiC transistor.

A system for providing high voltage DC is disclosed comprising a high DC power device. The high DC power device comprises a high DC voltage switch adapted to operate in a normally on mode, the switch to provide high DC voltage to a HV bus when in ON state, a discharge switch adapted to provide controlled discharge path of the HV bus to a ground line, a set of high side switch and low side switch connected in a totem pole arrangement between terminal connectable to the HV bus and the ground line, a midpoint output terminal connected between the high side switch and low side switch, a first control terminal to provide control signal to change the mode of the high DC voltage switch between ON state and OFF state, a second control terminal to provide control signal to change the mode of the discharge switch between ON state an OFF state and a third and a fourth control terminals to provide control signals to change the mode of the high side switch and of the low side switch, respectively, between ON state and OFF state. The system further comprises a half-bridge rectifier to provide rectified AC voltage to the high DC power device, an inductor and a rectifying PFC unit connected in series between the output of the high DC voltage switch and the high voltage output terminal and a controller adapted to provide control signals for opening and closing at least one of the high DC voltage switch, the discharge switch, the high side switch and the low side switch.

In some embodiments, the system further comprises a memory unit. The memory unit comprises, stored thereon, program code that, when executed, provides control signals that control the operation of the high DC voltage switch and the discharge switch so as to cause gradual rising of the high DC voltage at the beginning of the operation of the system and gradual discharge of the high DC line at the end of the operation of the system.

In some embodiments, each of the high DC voltage switch, the discharge switch, the high side switch and the low side switch may be GaN HEMT transistor or SiC transistor.

A method for controlling the operation of high DC voltage circuit is disclosed comprising, when high DC voltage circuit is in OFF state, providing high AC voltage to the high DC voltage circuit when a high DC voltage switch, a discharge switch, a high side switch and a low side switch of the high DC voltage circuit are in OFF states, providing bias DC voltage to a controller of the high DC voltage circuit, delaying operation of the controller for a first time delay to allow the bias DC to stable before operating the controller and applying by the controller to the high DC voltage switch control signals according to soft start modulation scheme, until the high DC voltage switch is continuously opened.

When the high DC voltage circuit is in ON state and needs to shut down applying by the controller to the high DC voltage switch and to the discharge switch control signals according to soft shut off modulation scheme, until the high DC voltage at a high DC bus reduces to zero and delaying shut off of the bias DC voltage to allow for safe shut off of the controller.

In some embodiments, the soft start modulation scheme comprises applying ON signals of a continuously lengthening period of time, starting with a ON signal of a length of one percent or less of the AC cycle time, the ON signal is timed substantially symmetrically around a zero crossing time of the input AC voltage, until the resulting ON signals form a continuous ON signal.

In some embodiments, the soft shut off modulation scheme comprises applying ON signals of a continuously shortening period of time, starting with a signal length of substantially half AC cycle, wherein the ON signal is timed substantially symmetrically around a zero crossing time of the input AC voltage, until the resulting ON signals form a continuous ON signal.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic block diagram depicting a circuit for providing switched high DC voltage using normally open transistors, according to some embodiments of the present invention;

FIG. 2 is a schematic electronic scheme of a circuit for providing switched high DC voltage using normally open transistors, according to some embodiments of the present invention;

FIG. 3 is a schematic electronic circuit of an integrated chip for controlling a circuit providing switched high DC voltage, according to embodiments of the present invention;

FIG. 4A depicts time graphs of the AC input signal, the DC bias voltage, the high voltage bus and the switching of the normally open transistor, according to some embodiments of the present invention;

FIG. 4B depicts time graphs of the AC input signal, the power switch modulation signals controlling the switching of the normally open transistor and the high voltage bus during gradual power in stage after starting the high voltage normally on unit, according to some embodiments of the present invention; and

FIG. 5 is a schematic flow diagram depicting a method for providing switched high DC voltage, according to some embodiments of the present invention.

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence.

Additionally, some of the described method embodiments or elements thereof can occur or be performed simultaneously, at the same point in time, or concurrently.

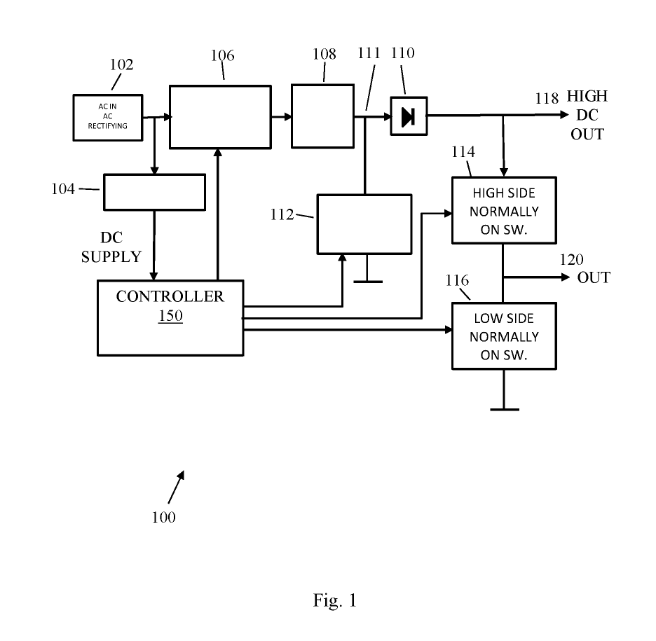

Reference is made now to FIG. 1, which is a schematic block diagram depicting a circuit 100 for providing switched high DC voltage using normally open transistors, according to some embodiments of the present invention. Circuit 100 is adapted to be fed by high AC voltage at AC input terminal 102A, to provide bias DC voltage for powering the control functions of circuit 100 prior to allowing providing of high DC voltage to its output, to provide controlled switching of a transistor operating in a ‘normally open’ mode in order to provide soft rising of the voltage on the output DC high voltage bus, to protect the circuit from high voltage peaks developing on the inductor comprised in the circuit and to enforce gradual (soft) discharge of the high voltage DC bus when this bus is turned to OFF state, as is explained in details herein below.

Circuit 100 further comprises AC-DC rectifying unit included in AC rectifying unit 102. This unit may be fed by high AC voltage, e.g. 220 VAC/50 Hz, and provide high DC voltage at its output at point 103. The DC voltage at point 103 may be used to power bias DC unit 104 which is adapted to provide DC power to circuit control unit 150, e.g., 5VDC. High DC voltage switch (HDCVS) unit 106 is a controlled solid state switch adapted to operate in the ‘normally on’ mode, such as a IGBT type transistor or a silicon controlled rectifier (SCR). Initially, HDCVS 106 is kept (in its default state) in OFF state to prevent undesired high inrush current through it. HDCVS 106 may be controlled by controller unit 150, to allow flow of DC current through it when conditions are right, as is explained in details herein below.

When HDCVS 106 is in its normally on state and high DC current flows through it, inductor 108 that may be connected in series to HDCVS 106 may ensure that electromagnetic interferences (EMI) peaks of input current are reduced or even completely blocked.

Rectifier unit 110 that may be connected in series on the high DC voltage line may act as a typical power factor corrector (PFC).

Output line 111 from inductor 108 may be connected to common/ground line for purposes of controlled discharge via high DC voltage discharge unit 112. Discharge unit 112 may comprise a controllable solid state switch that may discharge high voltage from line 11 to the ground bus as is explained in detail below.

The high DC voltage provided by unit 100 may comprise two different output terminals: high DC voltage output terminal 118 may provide. Output 118 is the high voltage of the rectified AC voltage, output 120 is the midpoint of high and low sides of normally on switches. Output DC terminal 120 may be positioned between high side normally open controllable solid state switch 114 and low side normally open controllable solid state switch 116, adapted to provide high side and low side switches that may act as a half bridge—the output 120 is the midpoint of the half bridge structure.

The timing scheme controlling the operation of unit 100 will be explained in detail herein below.

Controller unit 150 may be any suitable controller, CPU or programmable controller or the like, that may comprise, or be associated with memory unit (not shown) which may store in it program code that when executed perform the steps of operation of unit 100, as described herein below. Controller 150 may further comprise input and optionally output units to enable loading program and/or data to the memory unit and/or to update the program(s) stored thereon.

Controller 150 may be, for example, a central processing unit processor (CPU), a chip or any suitable computing or computational device. Controller unit 150 may have stored in it an operating system and an executable code. Controller 105 may be configured to carry out methods described herein and/or to execute or act as the various modules, units, etc.

Memory unit may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory unit may be or may include a plurality of, possibly different memory units. The memory unit may be a computer or processor non-transitory readable medium, or a computer non-transitory storage medium, e.g., a RAM.

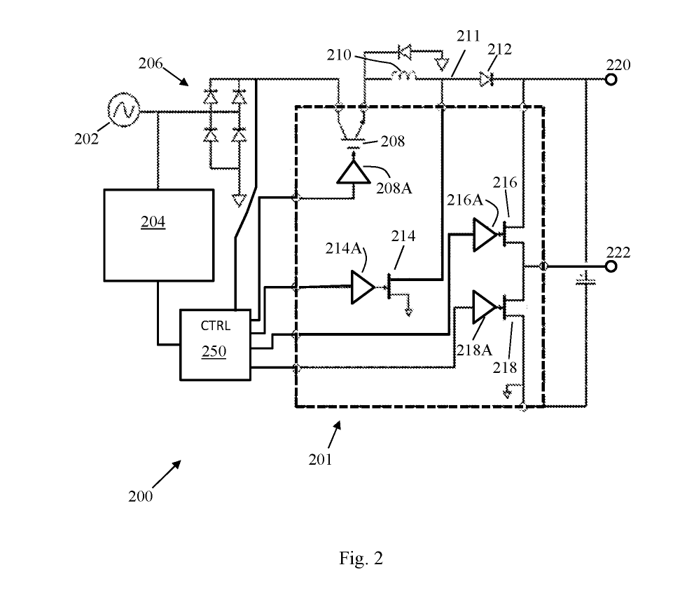

Reference is made now to FIG. 2, which is a schematic electronic scheme of circuit 200 for providing switched high DC voltage using normally open transistors, according to some embodiments of the present invention. Circuit 200 provides electronic scheme that may be used for performing the operation of the schematic block diagram of FIG. 1. Circuit 200 may have some of its elements embodied on a single unit 201, such as a single silicone chip. High AC voltage may be provided to circuit 200 at AC input terminal 202. Unit 204 may be adapted to be fed from the rectified AC voltage and to supply DC bias voltage for operating the control unit.

Circuit 200 comprises AC rectifying unit 206, for example a diode half bridge as in FIG. 2 or a diode full bridge, or the like. AC rectifying unit 206 is adapted to be fed with high AC voltage and to provide high DC voltage to circuit 200. Circuit 200 may further comprise AC monitoring unit 204, adapted to monitor the input high AC voltage source and to provide indication of the AC voltage parameters, such as amplitude, frequency, RF interferences and the like, to controller unit 250.

High DC voltage switch (HDCVS) unit 208 may have a functionality and role similar or exactly as those HDCVS unit 106. In order to enable proper control of the operation of HDCVS unit 208 by a controller, driving unit 208A may be connected in series to the control terminal of HDCVS unit 208, for example in order to match signal levels and polarity of the signals provided by the controller to those required at the control terminal of HDCVS unit 208. When of HDCVS unit 208 is in ON state high DC voltage casus DC current to flow through it and via inductor 210, which is similar in function and role to inductor 108 (of FIG. 1) and via rectifier unit 212 to high DC voltage output terminal 220, similar in role and function to terminal 118 (of FIG. 1). Rectifier unit 212 may be adapted to function as a PFC, similarly to rectifying unit 110 (FIG. 1).

Between terminal 220 and the ground line, a high side normally open controllable solid state switch 216 and low side normally open controllable solid state switch 218 may be connected in series in a totem pole arrangement between terminal 220 and the ground line, controlling output terminal 222 connected between them. High side normally open controllable solid state switch 216 is similar to switch 114, and low side normally open controllable solid state switch 218 is similar to switch 116. Each of switches 216 and 218 may be driven by controller 250 via a respective driver 216A and 218A.

Controller unit 250 may be similar to controller unit 150 of FIG. 1 in structure and functionality. Accordingly, controller unit 250 may comprise memory unit storing program code and data that when executed perform the functions and steps of a high DC voltage, normally on switch unit, such as switch unit 200, as described herein below.

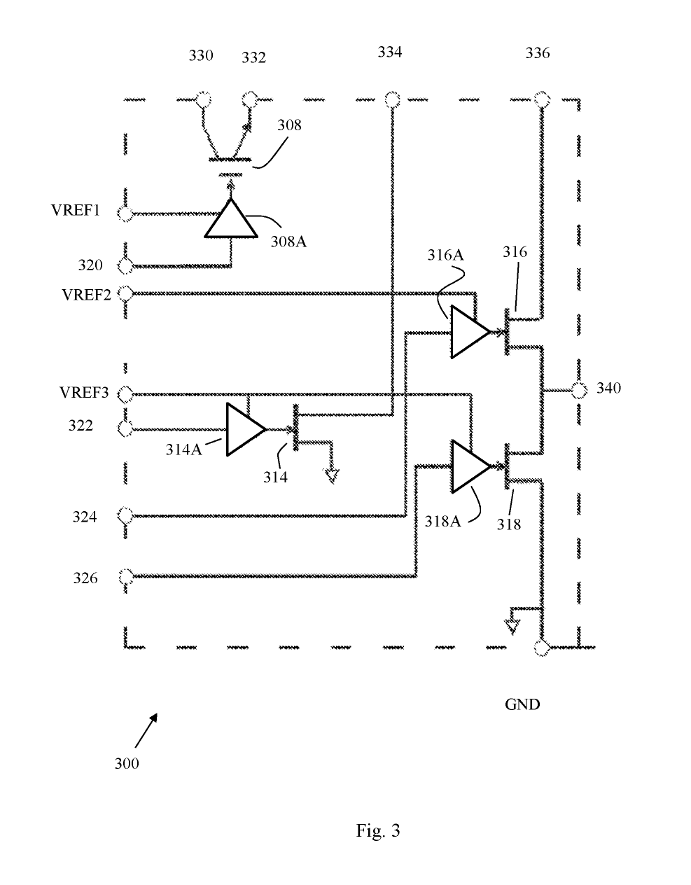

Reference is made to FIG. 3, which is a schematic electronic circuit of high DC power device 300 for controlling the operation of a circuit for providing switched high DC voltage, according to some embodiments of the present invention. Integrated circuit (IC) chip 300 may be structured and functioning similar to unit 201 of FIG. 2. IC unit 300 may comprise high DC voltage switch (HDCVS) 308, similar to HDCVS 208, adapted to receive rectified high DC voltage at HDCV input terminal 330 and to provide controlled high DC voltage at HDCV output terminal 332. An external inductor (not shown here) may be connected between terminal 332 and terminal 334 and an external rectifier unit, similar to rectifier unit 212 (FIG. 2), may be connected between terminal 334 and terminal 336, where high DC voltage bus may be connected.

A controlled discharge circuitry comprising soft solid state switch 314 and driver 314A may be connected between terminal 334 and the ground line, to enable controlled discharge of high DC voltage when needed.

High side normally open controllable solid state switch 316 and low side normally open controllable solid state switch 318 may be connected in series in a totem pole arrangement between terminal 336 and the ground terminal between terminal 336 and the ground line, controlling output terminal 340 connected between them. High side normally open controllable solid state switch 316 is similar to switch 216, and low side normally open controllable solid state switch 318 is similar to switch 218. Each of switches 316 and 318 may be driven by a controller via a respective drivers 316A and 318A.

There is an advantage in packing all units of IC 300 in a single chip, such as simpler and cheaper production, lower occupied space, simpler integration and lower stray induction of the switches, which enables operation in higher frequencies.

IC unit 300 may have plurality of input terminals for receiving control signals. HDCVS 308 may be controlled by a control signal provided to driver 308A via terminal 320 and a respective reference voltage may be provided at terminal VREF1. Controlled discharge may be done using a signal provided to driver 314A via terminal 322 and a respective reference voltage VREF3 may be provided at terminal VREF3. Output switches 316 and 318 may be controlled by control signals provided at terminals 324 and 326 to drivers 316A and 318A, respectively. Driver 316A may receive reference voltage from terminal VREF2, and driver 318A may receive reference voltage via terminal VREF3. Output voltage may be received at output terminal 340.

According to some embodiments, in at least one of the transistors 308, 314, 316 and 318, a resistor in the range of at least several mega ohms may be connected between its source and its die backside, to help to reduce the drain leakage and current collapse effect, as was proved by measurements.

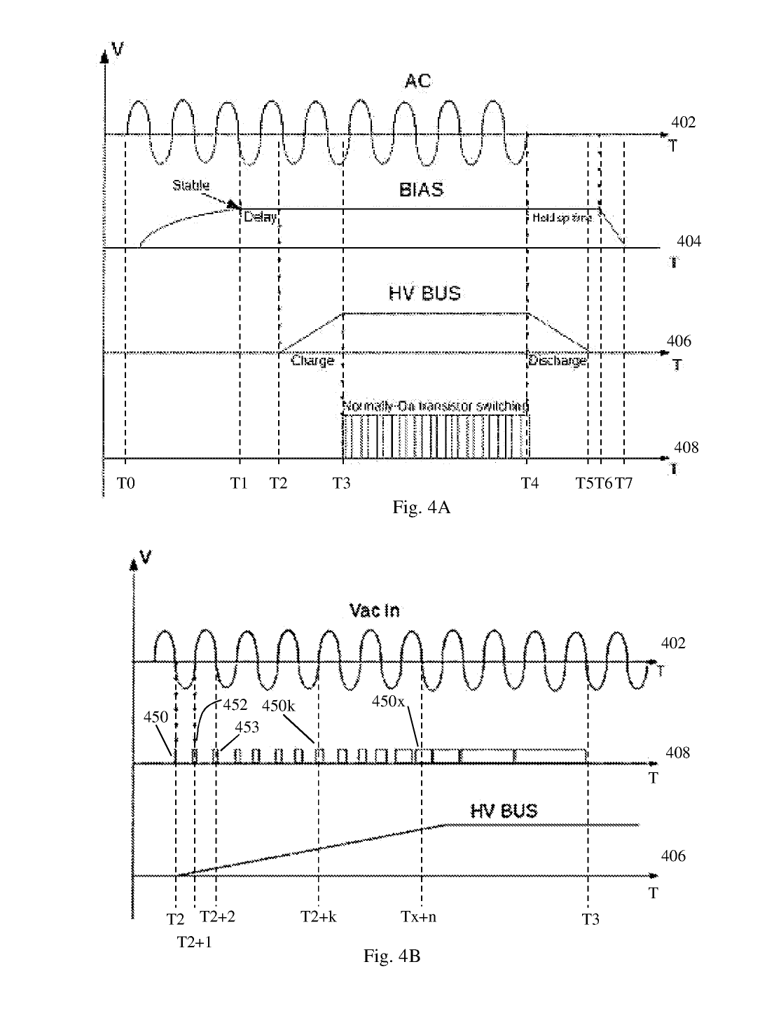

Reference is made now to FIG. 4A, which depicts time graphs of the AC input signal, the DC bias voltage, the high voltage bus and the switching of the normally open transistor, according to some embodiments of the present invention. Graph 402 presents the AC voltage wave form at the input terminal. Graph 404 depicts the DC bias voltage as a function of time. Graph 406 depicts the voltage of the high voltage bus as a function of time and graph 408 presents the modulation signals of normally on power switch on the high DC voltage line such as switches 106, 208 and 308. When high AC voltage is present at the AC input terminal, at TO DC bias voltage starts building up until, at time T1 the DC bias voltage is stable and ensures proper operation of the control of the units. A delay between T1 and T2 may be provided for safety, and then, between T2 and T3, high DC voltage power switch may gradually be opened at timed instances of the input AC wave to enable gradual rising (soft rise) of the voltage of HV Bus, as explained in details with respect to FIG. 4B.

At time T3, the voltage of HV Bus is stable and has reached its desired level, and the normally on power transistor is continuously opened. When, at time T4, switching of the high DC voltage is required, gradual (soft) power off procedure is taken, similar to that which took during soft power on, now controlling both the high voltage normally on power transistor and the discharge power transistor, such as switches 112, 214 and 314, until at time T5, the voltage on HV Bus is zero and, after safety hold up period of time between T4 and T6, which is longer than T5-T4, discharge of the bias voltage takes place and at T7 it reaches zero volts.

This scheme ensures that, prior to operating the high voltage normally on power transistor, stable DC bias voltage will be provided to the control circuitry, to ensure safe operation. This control scheme further ensures that the current via the high voltage normally on power transistor will be built up gradually to prevent high in rush hazards. Similarly, shut down of the unit is done gradually to eliminate hazards occurring due to abrupt changes in currents and/or voltages.

Reference is made now to FIG. 4B, which depicts time graphs of the AC input signal, the power switch modulation signals controlling the switching of the normally open transistor and the high voltage bus during gradual power in stage after starting the high voltage normally on unit, according to some embodiments of the present invention. Graphs 402, 406 and 408 here depict in an enlarged time scale the control modulation signals (graph 408) between time T2 and T3, when the power on the high voltage DC power line is gradually built. From time T2, at zero-crossing of the AC wave at the input, modulation signal 450, having a narrow width in time, is provided to the power transistor to open the transistor for that period of time, at AC crossing time T2+1 that comes after T2, modulation signal 452 which is a bit longer than signal 450 opens the power transistor. Similarly, modulation signals 453, 450k and 450x open the power transistor for consecutive periods of times which get longer and longer, while switching is done around the zero crossing of the input wave form, to eliminate high undesired voltages on the power terminals of the power transistor. Accordingly, the voltage on the HV Bus gradually rises, thus ensuring hazard free power-up of the power transistor.

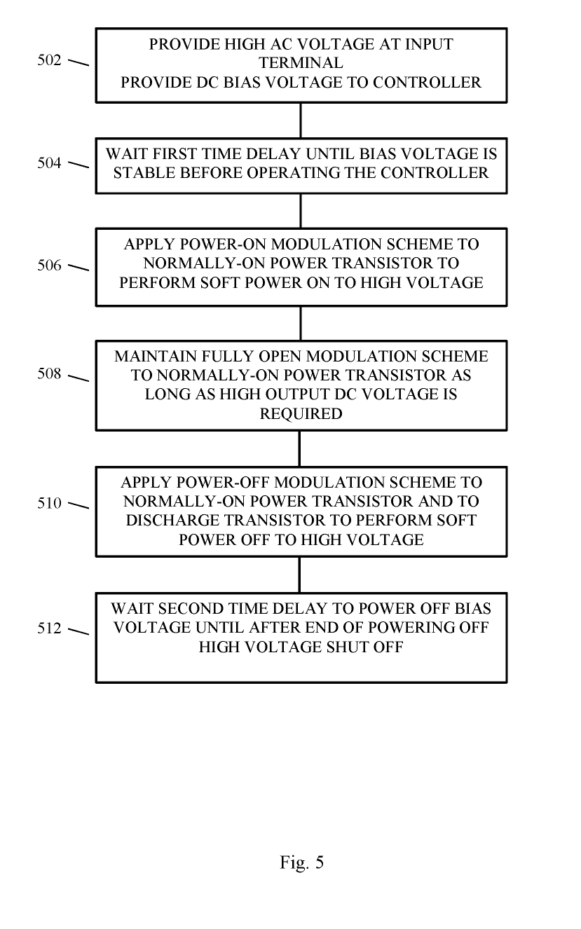

Reference is made now to FIG. 5, which is a schematic flow diagram depicting a method for providing switched high DC voltage, according to some embodiments of the present invention. When a unit for providing switched high DC voltage using normally open transistor, such as units 100 and 200, begins operation, high AC voltage is provided to the AC terminal of the unit, and rectified bias DC voltage is provided to control circuitry of the unit (block 502). After a first time delay from the step of block 502 terminates (block 504), soft power on modulation scheme may be applied to the normally-on power transistor (block 506). When soft power on stage finishes, the power transistor is kept in ON state as long as high voltage DC power at the output of the unit is required (block 508). When the high voltage DC power is to be shut off, a soft power off procedure may be applied, possibly reverse of the soft power on procedure (block 510). After a second time delay from shut off of the power transistor, DC bias voltage is shut off.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A device for controlling an AC fed normally on switch for high voltage DC comprising:
a high DC voltage switch adapted to operate in a normally on mode, the switch to provide high DC voltage to a HV bus when in ON state;
a discharge switch adapted to provide controlled discharge path of the HV bus to a ground line;
a set of high side switch and low side switch connected in a totem pole arrangement between terminal connectable to the HV bus and the ground line;
a midpoint output terminal connected between the high side switch and low side switch;
a first control terminal to provide control signal to change the mode of the high DC voltage switch between ON state and OFF state;
a second control terminal to provide control signal to change the mode of the discharge switch between ON state an OFF state; and
a third and a fourth control terminals to provide control signals to change the mode of the high side switch and of the low side switch, respectively, between ON state and OFF state.

2. The device of claim 1 further comprising at least one signal driver to match the signal of at least the first, the second, the third and the fourth control terminals to the input control terminal of the respective high DC voltage switch, the discharge switch, the high side switch and the low side switch, respectively.

3. The device of claim 1, wherein all the elements of the device are performed as an integrated circuit (IC) on a single chip.

4. The device of claim 1 wherein in at least one of the high DC voltage switch, the discharge switch, the high side switch and the low side switch a resistor in the range of at least several mega ohms may be connected between its source and its die backside.

5. The device of claim 1 wherein each of the high DC voltage switch, the discharge switch, the high side switch and the low side switch are transistors of one of GaN HEMT transistor or SiC transistor.

6. A system for providing high voltage DC comprising:
a high DC power device for providing switched high DC voltage, the high DC power device comprising:
a high DC voltage switch adapted to operate in a normally on mode, the switch to provide high DC voltage to a HV bus when in ON state;
a discharge switch adapted to provide controlled discharge path of the HV bus to a ground line;
a set of high side switch and low side switch connected in a totem pole arrangement between terminal connectable to the HV bus and the ground line;
a midpoint output terminal connected between the high side switch and low side switch;
a first control terminal to provide control signal to change the mode of the high DC voltage switch between ON state and OFF state;
a second control terminal to provide control signal to change the mode of the discharge switch between ON state an OFF state; and
a third and a fourth control terminals to provide control signals to change the mode of the high side switch and of the low side switch, respectively, between ON state and OFF state;
a half-bridge rectifier to provide rectified AC voltage to the high DC power device;
an inductor and a rectifying PFC unit connected in series between the output of the high DC voltage switch and the high voltage output terminal; and
a controller adapted to provide control signals for opening and closing at least one of the high DC voltage switch, the discharge switch, the high side switch and the low side switch.

7. The system of claim 6 wherein the controller comprises memory unit, the memory unit comprise stored thereon program code that when executed provides control signals controlling the operation of the high DC voltage switch and the discharge switch so as to cause gradual rising of the high DC voltage at the beginning of the operation of the system and gradual discharge of the high DC line at the end of the operation of the system.

8. The system of claim 6 wherein each of the high DC voltage switch, the discharge switch, the high side switch and the low side switch are transistors of one of GaN HEMT transistor or SiC transistor.

9. A method for controlling the operation of high DC voltage circuit, comprising:
when high DC voltage circuit is in OFF state:
providing high AC voltage to the high DC voltage circuit when a high DC voltage switch, a discharge switch, a high side switch and a low side switch of the high DC voltage circuit are in OFF states;
providing bias DC voltage to a controller of the high DC voltage circuit;
delaying operation of the controller for a first time delay to allow the bias DC to stable before operating the controller; and
applying by the controller to the high DC voltage switch control signals according to soft start modulation scheme, until the high DC voltage switch is continuously opened;
when high DC voltage circuit is in ON state and need to shut down:
applying by the controller to the high DC voltage switch and to the discharge switch control signals according to soft shut off modulation scheme, until the high DC voltage at a high DC bus reduces to zero; and
delaying shut off of the bias DC voltage to allow for safe shut off of the controller.

10. The method of claim 9, wherein the soft start modulation scheme comprises applying ON signals of a continuously lengthening period of time, starting with a ON signal of a length of 1 percent of the AC cycle time, the ON signal is timed substantially symmetrically around a zero crossing time of the input AC voltage, until the resulting ON signals form a continuous ON signal.

11. The method of claim 9 wherein the soft shut off modulation scheme comprises applying ON signals of a continuously shortening period of time, starting with a signal length of substantially half AC cycle, the ON signal is timed substantially symmetrically around a zero crossing time of the input AC voltage, until the resulting ON signals form a continuous ON signal.
